(19) United States
(12) Patent Application Publication
(10) Pub. No.: US 2026/0018885 A1
(43) Pub. Date: Jan. 15, 2026

(54) SOLAR DIRECT DRIVE METHOD AND SYSTEM

(71) Applicant: MOTOR COMPETENCE CENTER HOLDING FLENSBURG GMBH, Flensburg (DE)

(72) Inventors: Hendrik MOELLER, Flensburg (DE); Ole BACHMANN-SCHEBEL, Flensburg (DE)

(21) Appl. No.: 18/880,086

(22) PCT Filed: Jun. 27, 2023
(86) PCT No.: PCT/EP2023/067477

§ 371 Date: Dec. 30, 2024

(30) Foreign Application Priority Data
Jun. 29, 2022 (EP) 22181727.3

(51) Int. Cl. H02J 1/14; H02P 6/08

(52) U.S. Cl. CPC H02J 1/14; H02P 6/08; H02J 2300/24; H02J 2310/60

(57) ABSTRACT

The present invention relates to a method for powering a motor directly from a photovoltaic module, wherein the motor is adapted to drive a piston compressor pump, the method comprising the steps of determining an available amount of power from the photovoltaic module, and starting the motor if the available amount of power exceeds a predetermined power level, repeatedly determining, within a predetermined time period, an available amount of power from the photovoltaic module while operating the motor, and adjusting the speed of rotation of the motor in accordance with the repeatedly determined available amount of power. The present invention also relates to a power unit for powering a motor directly from a photovoltaic module, and to a cooling device for cooling pharmaceuticals.

### FIELD OF THE INVENTION

The present invention relates to a solar direct drive (SDD) method and module for cooling systems, such as refrigerators. The present invention relates in particular to methods and systems where power reservoirs, such as batteries, are omitted.

### BACKGROUND OF THE INVENTION

Traditional photovoltaic power supply systems typically involve a number of photovoltaic panels electrically coupled in series or parallel, a power distribution device and a battery bank so that excess power from the photovoltaic panels can be stored for later use. The traditional systems are however disadvantageous for various reasons, such as the costs and the massive weight of the battery bank. Moreover, the availability and maintenance of battery banks at remote locations may be challenging.

Thus, there seems to be a need for simpler photovoltaic power supply systems that may be operated, in particular, at remote locations. In particular, there seems to be a need for photovoltaic power supply systems where the battery bank is omitted.

It may be seen as an object of embodiments of the present invention to provide a direct drive method and system for motors driving a piston compressor pump.

It may be seen as a further object of embodiments of the present invention to provide a direct drive method and system for motors driving a piston compressor pump where the number of starts and stops are significantly reduced in order to reduce wear.

It may be seen as an even further object of embodiments of the present invention to provide an inverse protective element for ensuring correct polarity of a DC photovoltaic module, and an integrated controllable switching arrangement for controlling an amount of power to be provided by the power unit via a DC power input port and/or an external AC power input port.

### DESCRIPTION OF THE INVENTION

The above-mentioned object is complied with by providing, in a first aspect, a method for powering a motor directly from a photovoltaic module, wherein the motor is adapted to drive a piston compressor pump, the method comprising the steps of
a) determining an available amount of power from the photovoltaic module, and starting the motor if the available amount of power exceeds a predetermined power level,
b) repeatedly determining, within a predetermined time period, an available amount of power from the photovoltaic module while operating the motor, and
c) adjusting the speed of rotation of the motor in accordance with the repeatedly determined available amount of power.

Thus, the first aspect of the present invention relates to a method for powering a motor directly from a photovoltaic module. This direct powering of the motor is advantageous in that for example costly battery banks can be completely omitted. It is moreover advantageous that adjusting the speed of rotation of the motor in accordance with the repeatedly determined available amount of power may 1) facilitate that the motor and the piston compressor pump is, at all times, operated to provide maximum cooling, 2) minimise the number of starts and stops of the motor significantly whereby unnecessary wear is reduced, and 3) avoid collapse of the photovoltaic module.

The present invention may be used in relation to portable cooling devices for cooling for example pharmaceuticals at remote locations where traditional AC power grids are either unstable/unreliable or simply not available.

In the present context a photovoltaic module is a module that converts light, such as incoming natural sun light (solar irradiance), into electrical power, such as DC power. A photovoltaic module may comprise a single photovoltaic panel or it may comprise a plurality of photovoltaic panels. The number of photovoltaic panels may vary from a single panel to hundreds or even thousands of panels. Each photovoltaic panel typically comprises a plurality of photovoltaic cells.

The motor may be a brushless DC motor/synchronous permanent magnet machine. A converter may be provided for starting and operating the motor. The converter may comprise an inverter comprising a controllable B6 inverter bridge configured to provide a three-phase AC power drive output for driving the motor and the piston compressor pump operatively connected thereto.

As it will be discussed in further details below the available amount of power from a photovoltaic module depends on the amount of incoming natural sun light which typically depends on the position of the sun relative to the photovoltaic module, clouds, dirt on the photovoltaic module etc.

The predetermined power level is to be understood as the amount of power required to start and operate the motor and the associated piston compressor pump in a safe manner without reducing the lifetime thereof unnecessary. The predetermined power level, at which the motor may be started, depends on the motor to be powered. In relation to portable cooling devices the predetermined power level for starting the motor may be at least 50 W, such as at least 60 W, such as at least 70 W, such as at least 80 W, such as at least 90 W, such as at least 100 W. The available of amount of power may be determined at least twice within a time period of for example 100-300 ms, and the motor is only started if the available of amount of power is equal to or exceeds the predetermined power level in both measurements. If the predetermined power level is not available from the photovoltaic module the motor may not be started. In this scenario the available amount of power from the photovoltaic module may be determined at a later stage, and if the available amount of power exceeds the predetermined power level at this later stage the motor may be started.

The determined available amount of power from the photovoltaic module prior to stating the motor may be determined using a P-V curve of the photovoltaic module. A P-V curve of a photovoltaic module may be a curve that links a terminal voltage of the photovoltaic module to an available power level. Thus, by measuring the terminal voltage of the photovoltaic module the available power may immediately be determined from the P-V curve.

During operation of the motor, i.e. while operating the motor, the repeatedly determined available amount of power from the photovoltaic module may also be determined using a P-V curve of the photovoltaic module. Thus, the available amount of power from the photovoltaic module may be determined in similar manners prior and during operation of the motor. The speed of rotation of the motor may be essentially proportional to the repeatedly determined available amount of power from the photovoltaic module. Thus, if the repeatedly determined available amount of power decreases a certain percentage the speed of rotation of the motor is decreased accordingly.

Moreover, during operation of the motor the repeatedly determined available amount of power from the photovoltaic module may be determined at least twice within the predetermined time period. This predetermined time period may be between 100-300 ms, such as between 150-250 ms, such as between 175-225 ms, such as approximately 200 ms. The predetermined time period may also be variable over time and thus not a fixed time period.

In a second aspect, the present invention relates to a power unit for powering a motor directly from a photovoltaic module, wherein the motor is adapted to drive a piston compressor pump, the power unit comprising
a) a first arrangement for determining an available amount of power from the photovoltaic module,
b) a converter for starting the motor if the determined available amount of power from the photovoltaic module exceeds a predetermined power level, and
c) a second arrangement for repeatedly determining, within a predetermined time period, an available amount of power from the photovoltaic module while operating the motor, and adjusting, using the converter, the speed of rotation of the motor in accordance with the repeatedly determined available amount of power.

Thus, the second aspect of the present invention relates to a power unit for powering a motor directly from a photovoltaic module. As already addressed this direct powering of the motor is advantageous in that for example costly battery banks can be completely omitted. It is moreover advantageous that adjusting the speed of rotation of the motor in accordance with the repeatedly determined available amount of power may 1) reduce the number of starts and stops of the motor significantly whereby unnecessary wear is reduced, and 2) avoid collapse of the photovoltaic module. It is also advantageous that the motor and the piston compressor pump may, at all times, be operated to provide maximum cooling.

The power unit may be used in relation to portable cooling devices for cooling for example pharmaceuticals at remote locations where traditional AC power grids are either unstable/unreliable or simply not available.

Again, a photovoltaic module is to be understood as a module that converts light, such as incoming natural sun light, into electrical power, such as DC power. A photovoltaic module may comprise a single photovoltaic panel or it may comprise a plurality of photovoltaic panels. The number of photovoltaic panels may vary from a single panel to hundreds or even thousands of panels. Each photovoltaic panel typically comprises a plurality of photovoltaic cells.

Similar to the first aspect the motor may be a brushless DC motor/synchronous permanent magnet machine. The converter for starting and operating the motor may comprise an inverter comprising a controllable B6 inverter bridge configured to provide a three-phase AC power drive output for driving the motor and the piston compressor pump. The converter may be adapted to adjust the speed of rotation of the motor so that it is essentially proportional to the repeatedly determined available amount of power from the photovoltaic module. Thus, if the repeatedly determined available amount of power decreases a certain percentage the speed of rotation of the motor may be decreased accordingly using the converter.

As it will be discussed in further details below the available amount of power from a photovoltaic module depends on the amount of incoming natural sun light which typically depends on the position of the sun relative to the photovoltaic module, clouds, dirt on the photovoltaic module etc.

The predetermined power level is again to be understood as the amount of power required to start and operate the motor and the associated piston compressor pump in a safe manner without reducing the lifetime thereof unnecessary. The predetermined power level, at which the converter may start the motor, depends on the motor to be powered. In relation to portable cooling devices the predetermined power level for starting the motor may be at least 50 W, such as at least 60 W, such as at least 70 W, such as at least 80 W, such as at least 90 W, such as at least 100 W. Again, the available of amount of power may be determined at least twice within a time period of for example 100-300 ms, and the motor is only started if the available of amount of power is equal to or exceeds the predetermined power level in both measurements. If the predetermined power level is not available from the photovoltaic module the motor may not be started. In this scenario the available amount of power from the photovoltaic module may be determined at a later stage, and if the available amount of power exceeds the predetermined power level at this later stage the motor may be started.

The first arrangement may be adapted to determine the available amount of power from the photovoltaic module, prior to stating the motor, using a P-V curve of the photovoltaic module. As already explained a P-V curve of a photovoltaic module may be a curve that links a terminal voltage of the photovoltaic module to an available power level. Thus, by measuring the terminal voltage of the photovoltaic module the available power may immediately be determined from the P-V curve.

During operation of the motor, i.e. while operating the motor, the second arrangement may be adapted to repeatedly determine the available amount of power from the photovoltaic module using a P-V curve of the photovoltaic module. Thus, the available amount of power from the photovoltaic module may be determined in similar manners prior and during operation of the motor.

Moreover, during operation of the motor the repeatedly determined available amount of power from the photovoltaic module may be determined at least twice within the predetermined time period. This predetermined time period may be between 100-300 ms, such as between 150-250 ms, such as between 175-225 ms, such as approximately 200 ms. The predetermined time period may also be variable over time and thus not a fixed time period.

The power unit according to the second aspect may further be configured for powering the motor at least partly from an external AC power source, such as an AC power grid and/or an AC genset. In case an external AC power source is available this power source may be connected to the power unit where it may be converted to DC using an AC/DC converter. An inverter, comprising a controllable B6 inverter bridge, may be configured to provide a three-phase AC power drive output for driving the motor and the piston compressor pump.

In a third aspect, the present invention relates to a cooling device for cooling pharmaceuticals comprising a power unit according to the second aspect. The cooling device may further comprise an ice bank, i.e. a cooling reservoir, for separate cooling purposes of the cooling device. The ice bank may be used to cool the pharmaceuticals in the absence of sun light and/or an AC power source.

The photovoltaic modules applied in relation to the present invention may be rigid semiconductor photovoltaic modules, flexible foil-based photovoltaic modules or a combination thereof. The photovoltaic panels forming the photovoltaic module or modules may be electrically connected in series or in parallel depending on the desired terminal voltage of the photovoltaic module or modules.

Both the method and the power unit aim at operating the motor at a working point with maximum available power from the photovoltaic module as this allows that the motor may be operated at the highest possible rotational speed, and that excess cooling capabilities may be stored in an ice bank for later cooling purposes, such as cooling pharmaceuticals. The duration of such later cooling purposed may be several days.

In the fourth aspect the present invention relates to a power unit for powering a motor adapted to drive a piston compressor pump, the power unit comprising
a) a DC power input port adapted to be operationally connected to a DC photovoltaic module, and an inverse protective element for ensuring that the polarity of the DC photovoltaic module at the DC power input port is correct,
b) an AC power input port adapted to be operationally connected to an external AC power source, and
c) a controllable switching arrangement adapted to control an amount of power to be provided by the power unit via the DC power input port and/or the external AC power input port, wherein at least part of the controllable switching arrangement forms part of the inverse protective element.

Thus, the fourth aspect of the present invention relates to a power unit for powering a motor from a photovoltaic module and/or from an external AC power source, preferably directly from a photovoltaic module and/or from an external AC power source. As already addressed direct powering of the motor is advantageous in that for example costly battery banks can be completely omitted. It is moreover advantageous that adjusting the speed of rotation of the motor in accordance with the repeatedly determined available amount of power may 1) reduce the number of starts and stops of the motor significantly whereby unnecessary wear is reduced, and 2) avoid collapse of the photovoltaic module. It is also advantageous that the motor and the piston compressor pump may, at all times, be operated to provide maximum cooling.

The incorporation of the inverse protective element is advantageous in that it ensures that the polarity of the DC photovoltaic module at the DC power input port is correct whereby damage to both the power unit and the DC photovoltaic module can be avoided. It is moreover advantageous that at least part of the controllable switching arrangement forms part of the inverse protective element as such an arrangement will save both space and costs due to fewer components.

The power unit may be used in relation to portable cooling devices for cooling for example pharmaceuticals at remote locations where traditional AC power grids are either unstable/unreliable or simply not available.

As already discussed, a photovoltaic module is to be understood as a module that converts light, such as incoming natural sun light, into electrical power, such as DC power. A photovoltaic module may comprise a single photovoltaic panel or it may comprise a plurality of photovoltaic panels. The number of photovoltaic panels may vary from a single panel to hundreds or even thousands of panels. Each photovoltaic panel typically comprises a plurality of photovoltaic cells.

Similar to the first and second aspects the motor may be a brushless DC motor/synchronous permanent magnet machine. The converter for starting and operating the motor may comprise an inverter comprising a controllable B6 inverter bridge configured to provide a three-phase AC power drive output for driving the motor and the piston compressor pump. The converter may be adapted to adjust the speed of rotation of the motor so that it is essentially proportional to the repeatedly determined available amount of power from the photovoltaic module. Thus, if the repeatedly determined available amount of power decreases a certain percentage the speed of rotation of the motor may be decreased accordingly using the converter.

The power unit may be adapted to power the motor at least partly from the external AC power source if the available power from the DC photovoltaic module is insufficient for powering the motor. Alternatively, the power unit may be adapted to power the motor exclusively from the DC photovoltaic module or from the external AC power source. The external AC power source may comprise an AC power grid and/or an AC genset. In case an external AC power source is available this power source may be connected to the power unit where it may be converted to DC using an AC/DC converter. An inverter, comprising a controllable B6 inverter bridge, may be configured to provide a three-phase AC power drive output for driving the motor and the piston compressor pump.

The power unit may further comprise a power controller adapted to determine an available power from the DC photovoltaic module. The available amount of power from a photovoltaic module depends on the amount of incoming natural sun light which typically depends on the position of the sun relative to the photovoltaic module, clouds, dirt on the photovoltaic module etc.

The motor may be started if a determined available amount of power from the DC photovoltaic module exceeds a predetermined power level which is to be understood as the amount of power required to start and operate the motor and the associated piston compressor pump in a safe manner without reducing the lifetime thereof unnecessary. The predetermined power level, at which the converter may start the motor, depends on the motor to be powered. In relation to portable cooling devices the predetermined power level for starting the motor may be at least 50 W, such as at least 60 W, such as at least 70 W, such as at least 80 W, such as at least 90 W, such as at least 100 W. Again, the available of amount of power may be determined at least twice within a time period of for example 100-300 ms, and the motor is only started if the available of amount of power is equal to or exceeds the predetermined power level in both measurements. If the predetermined power level is not available from the photovoltaic module the motor may not be started. In this scenario the available amount of power from the photovoltaic module may be determined at a later stage, and if the available amount of power exceeds the predetermined power level at this later stage the motor may be started.

To determine the available amount of power from the photovoltaic module, prior to stating the motor, a P-V curve of the photovoltaic module may be used. As already explained a P-V curve of a photovoltaic module may be a curve that links a terminal voltage of the photovoltaic module to an available power level. Thus, by measuring the terminal voltage of the photovoltaic module the available power may immediately be determined from the P-V curve.

During operation of the motor, i.e. while operating the motor, the available amount of power from the photovoltaic module may be repeatably determined using a P-V curve of the photovoltaic module. Thus, the available amount of power from the photovoltaic module may be determined in similar manners prior and during operation of the motor. The speed of rotation of the motor may be essentially proportional to the repeatedly determined available amount of power from the photovoltaic module. Thus, if the repeatedly determined available amount of power decreases a certain percentage the speed of rotation of the motor is decreased accordingly.

Moreover, during operation of the motor the repeatedly determined available amount of power from the photovoltaic module may be determined at least twice within the predetermined time period. This predetermined time period may be between 100-300 ms, such as between 150-250 ms, such as between 175-225 ms, such as approximately 200 ms. The predetermined time period may also be variable over time and thus not a fixed time period.

In a fifth aspect the present invention relates to a cooling device for cooling pharmaceuticals, the cooling device comprising a power unit according to the fourth aspect, and an ice bank for separate cooling purposes of the cooling device. The power unit may power a motor adapted to drive a piston compressor pump of the cooling device.

In a sixth aspect the present invention relates to a method for powering a motor adapted to drive a piston compressor pump, the method comprising the steps of providing a power unit comprising
a) a DC power input port adapted to be operationally connected to a DC photovoltaic module, and an inverse protective element for ensuring that the polarity of the DC photovoltaic module at the DC power input port is correct,
b) an AC power input port adapted to be operationally connected to an external AC power source, and
c) a controllable switching arrangement adapted to control an amount of power to be provided by the power unit via the DC power input port and/or the external AC power input port, wherein at least part of the controllable switching arrangement forms part of the inverse protective element
   and controlling the controllable switching arrangement in accordance with a predetermined control scheme.

Thus, the sixth aspect of the present invention relates to a method for powering a motor from a photovoltaic module and/or from an external AC power source, preferably directly from a photovoltaic module and/or from an external AC power source. As already addressed direct powering of the motor is advantageous in that for example costly battery banks can be completely omitted. It is moreover advantageous that adjusting the speed of rotation of the motor in accordance with the repeatedly determined available amount of power may 1) reduce the number of starts and stops of the motor significantly whereby unnecessary wear is reduced, and 2) avoid collapse of the photovoltaic module. It is also advantageous that the motor and the piston compressor pump may, at all times, be operated to provide maximum cooling.

The incorporation of the inverse protective element is also advantageous in that the inverse protective element ensures that the polarity of the DC photovoltaic module at the DC power input port is correct whereby damage to both the power unit and the DC photovoltaic module can be avoided. It is moreover advantageous that at least part of the controllable switching arrangement forms part of the inverse protective element as such an arrangement will save both space and costs due to fewer components.

The method may be used in relation to portable cooling devices for cooling for example pharmaceuticals at remote locations where traditional AC power grids are either unstable/unreliable or simply not available.

The predetermined control scheme may comprise the step of determining an available power from the DC photovoltaic module. More particularly, the predetermined control scheme may comprise the step of powering the motor at least partly from the external AC power source if the available power from the DC photovoltaic module is insufficient for powering the motor. The predetermined control scheme may also comprise the step of powering the motor exclusively from the DC photovoltaic module or exclusively from the external AC power source.

In the present context a photovoltaic module is a module that converts light, such as incoming natural sun light (solar irradiance), into electrical power, such as DC power. A photovoltaic module may comprise a single photovoltaic panel or it may comprise a plurality of photovoltaic panels. The number of photovoltaic panels may vary from a single panel to hundreds or even thousands of panels. Each photovoltaic panel typically comprises a plurality of photovoltaic cells. The external AC power source may comprise an AC power grid and/or an AC genset.

The motor may be a brushless DC motor/synchronous permanent magnet machine. A converter may be provided for starting and operating the motor. The converter may comprise an inverter comprising a controllable B6 inverter bridge configured to provide a three-phase AC power drive output for driving the motor and the piston compressor pump operatively connected thereto.

As it will be discussed in further details below the available amount of power from a photovoltaic module depends on the amount of incoming natural sun light which typically depends on the position of the sun relative to the photovoltaic module, clouds, dirt on the photovoltaic module etc.

The motor may be started if a determined available amount of power from the DC photovoltaic module exceeds a predetermined power level which is to be understood as the amount of power required to start and operate the motor and the associated piston compressor pump in a safe manner without reducing the lifetime thereof unnecessary. The predetermined power level, at which the converter may start the motor, depends on the motor to be powered. In relation to portable cooling devices the predetermined power level for starting the motor may be at least 50 W, such as at least 60 W, such as at least 70 W, such as at least 80 W, such as at least 90 W, such as at least 100 W. Again, the available of amount of power may be determined at least twice within a time period of for example 100-300 ms, and the motor is only started if the available of amount of power is equal to or exceeds the predetermined power level in both measurements. If the predetermined power level is not available from the photovoltaic module the motor may not be started. In this scenario the available amount of power from the photovoltaic module may be determined at a later stage, and if the available amount of power exceeds the predetermined power level at this later stage the motor may be started.

To determine the available amount of power from the photovoltaic module, prior to stating the motor, a P-V curve of the photovoltaic module may be used. As already explained a P-V curve of a photovoltaic module may be a curve that links a terminal voltage of the photovoltaic module to an available power level. Thus, by measuring the terminal voltage of the photovoltaic module the available power may immediately be determined from the P-V curve.

During operation of the motor, i.e. while operating the motor, the available amount of power from the photovoltaic module may be repeatably determined using a P-V curve of the photovoltaic module. Thus, the available amount of power from the photovoltaic module may be determined in similar manners prior and during operation of the motor. The speed of rotation of the motor may be essentially proportional to the repeatedly determined available amount of power from the photovoltaic module. Thus, if the repeatedly determined available amount of power decreases a certain percentage the speed of rotation of the motor is decreased accordingly.

Moreover, during operation of the motor the repeatedly determined available amount of power from the photovoltaic module may be determined at least twice within the predetermined time period. This predetermined time period may be between 100-300 ms, such as between 150-250 ms, such as between 175-225 ms, such as approximately 200 ms. The predetermined time period may also be variable over time and thus not a fixed time period.

In general, the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

The present invention will now be described in further details with reference to the accompanying figures where

FIG. 1 shows a typical amount of available power from a photovoltaic system, and a typical amount of required power for operating a cooling compressor between 4 am and 4 pm where cooling is needed,

FIG. 2a shows a prior art system comprising a plurality of photovoltaic modules coupled to a refrigerator and a battery bank, and FIG. 2b shows a SDD system according to the present invention,

FIG. 3 shows a functional block diaphragm of a SDD module,

FIG. 4 shows an overall logic flow chart,

FIG. 5 shows a logic flow chart of the PV Mode,

FIG. 6 shows three typical P-V curves of a photovoltaic module, and

FIG. 7 shows a SDD module comprising an inverse protective element for ensuring that the polarity of the DC photovoltaic module is correct when connected to the SDD module.

### DETAILED DESCRIPTION OF THE INVENTION

In general, the present invention relates to a method and a power unit for powering a motor directly from a photovoltaic module. The motor is adapted to drive a piston compressor pump of a cooling device, such as a portable cooling device. The direct powering of the motor from the photovoltaic module is advantageous in that for example costly battery banks can be completely omitted. It is moreover advantageous that the speed of rotation of the motor is adjusted in accordance with a repeatedly determined available amount of power as this, for example, significantly reduces the number of starts and stops of the motor whereby unnecessary wear is reduced. The present invention also facilitates that the motor and the piston compressor pump may, at all times, be operated to provide maximum cooling. The method and power unit may find use in relation to portable cooling devices for cooling for example pharmaceuticals at remote locations where traditional AC power grids are either unstable/unreliable or simply not available. In the following the terms “SDD module” and “power unit” may be used for the same device.

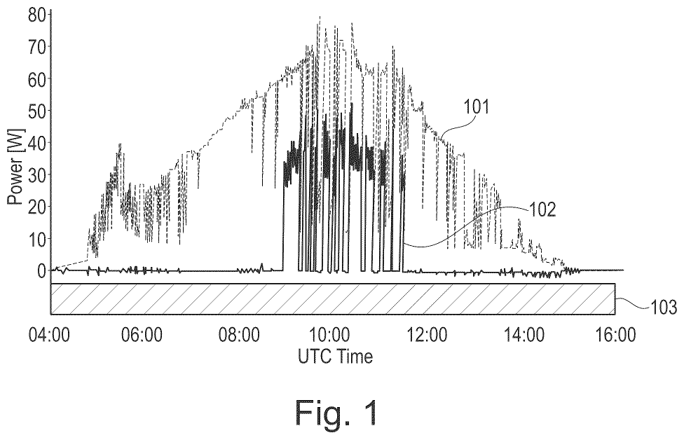

Referring now to FIG. 1 a typical amount of available power from a photovoltaic system (upper curve 101), and a typical amount of required power (lower curve 102) for operating a cooling compressor between 4 am and 4 pm is depicted. It is generally considered that sufficient power should be available for the cooling compressor between 4 am and 4 pm as indicated by the horizontal bar 103. The power fluctuations in the available power 101 from the photovoltaic system is due to clouds and dust that reduce the amount of incoming sun light. As seen in FIG. 1 the cooling compressor is periodically operated between 9 am and around 11:30 am although cooling is required between 4 am and 4 pm. A closer look at FIG. 1 reveals that the cooling compressor is only active when the available power from a photovoltaic system exceeds around 60 W. If the cooling compressor is active, at the available power from a photovoltaic system suddenly drops below 60 W the cooling compressor is temporarily stopped until the available power from the photovoltaic system again exceeds 60 W. Operating the motor and the cooling compressor in such a periodic manner is disadvantageous as it introduces unnecessary wear in the motor and the cooling compressor.

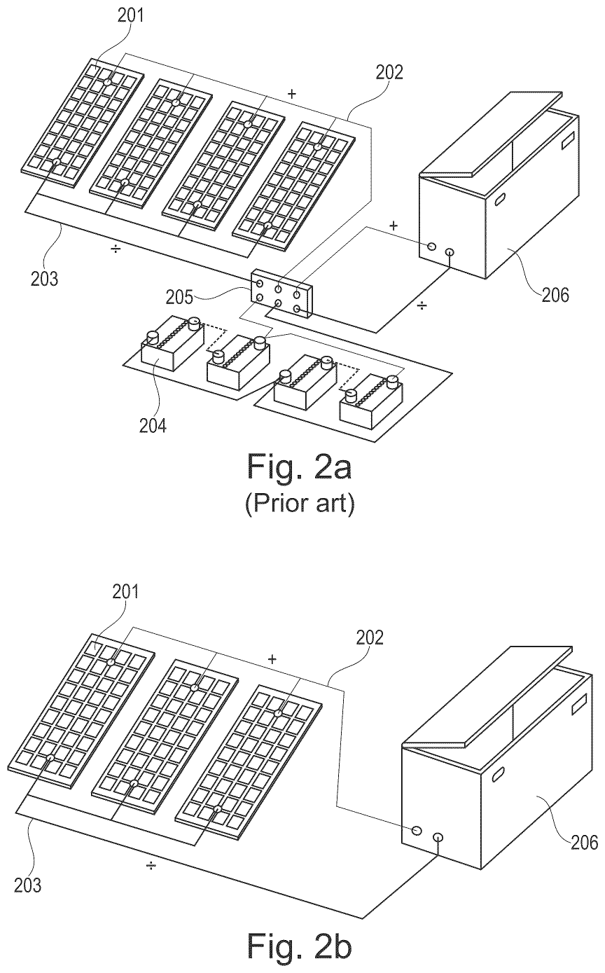

Turning now to FIG. 2a a prior art photovoltaic system is depicted. As seen in FIG. 2a the photovoltaic module comprises four photovoltaic panels 201 electrically coupled in parallel. The positive 202 and negative 203 voltage terminals are operatively connected to a power distribution device 205 which is electrically connected to four batteries 204 so that excess power from the four photovoltaic panels 201 can be stored for later use. The power distribution device 205 is also electrically connected to a load in the form of a refrigerator 206 which may be powered directly from the four photovoltaic panels 201, the four batteries 204 or a combination thereof. The prior art photovoltaic system depicted in FIG. 2a is disadvantageous for various reasons, such as the costs and the massive weight of the four batteries 204 as well as the availability, maintenance and environmental correct disposal of such batteries 204 at remote locations.

Referring now to FIG. 2b a photovoltaic system according to the present invention is depicted. The photovoltaic system depicted in FIG. 2b is significantly simpler compared to the prior art system depicted in FIG. 2a. As seen in FIG. 2b the refrigerator 206 is now exclusively powered from the photovoltaic panels 201 via the respective positive 202 and negative 203 voltage terminals. The power unit (not shown) of the present invention may from part of the refrigerator 206 or it may be arranged in connection with one of the photovoltaic panels 201. The photovoltaic system depicted in FIG. 2b is advantageous due to its simplicity and the fact that batteries can be completely omitted.

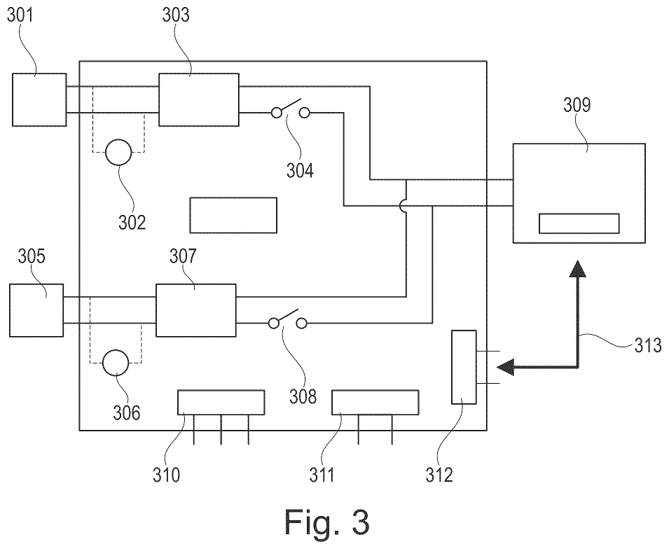

Turning now to FIG. 3 a SDD module according to the present invention is depicted. As seen in FIG. 3 the SDD module is configured to receive input power from photovoltaic panels 301 and optionally also from an AC power source 305. The AC power source 305 can be an AC power grid and/or an AC genset. The voltage of the power received from the photovoltaic panels 301 is measured by the measuring device 302 (voltmeter) before reaching the controllable DC/DC converter 303. As it will be discussed in further details below the terminal voltage of the photovoltaic panels 301 is a measure for the available amount of power from the photovoltaic panels 301 in that P-V curves associate a measured terminal voltage to an available amount of power. The output power from the DC/DC converter may be interrupted by opening the controllable switch 304 as depicted in FIG. 3. The voltage level received from the photovoltaic panels 301 is typically in the range 25-50 VDC, but this voltage level may be changed (reduced or boosted) with the DC/DC converter 303.

Similarly, the voltage of the power optionally received from the AC power source 305 is measured by the measuring device 306 (voltmeter) before reaching the controllable AC/DC converter 307. Again, output power from the AC/DC converter 307 be interrupted by opening the controllable switch 308 as depicted in FIG. 3. The voltage level received from the AC power source 305 may for example be 110 VAC or 240 VAC (60/50 Hz), but also this voltage level may be changed by the AC/DC converter 307.

The power output from the SDD module (to the compressor control 309) may thus originate exclusively from the photovoltaic panels 301 or the AC power source 305, or it may originate from a combination of the photovoltaic panels 301 and the AC power source 305. The nominal output voltage level of the SDD module is typically in the range of 25-55 VDC.

The DC output power from the SDD module is provided to a DC/AC converter (not shown) for operating the brushless DC motor/synchronous permanent magnet machine in accordance with the available amount of power from the photovoltaic panels 301. As already mentioned, the DC/AC converter may comprise an inverter comprising a controllable B6 inverter bridge configured to provide a three-phase AC power drive output for driving the brushless DC motor/synchronous permanent magnet machine and the piston compressor pump operatively connected thereto. The SDD module further provides DC power supplies to externals devices at for example 5 VDC or 24 VDC, as well as communication ports 311, 312 to external devices, such as a communication path 313 to the compressor control 309.

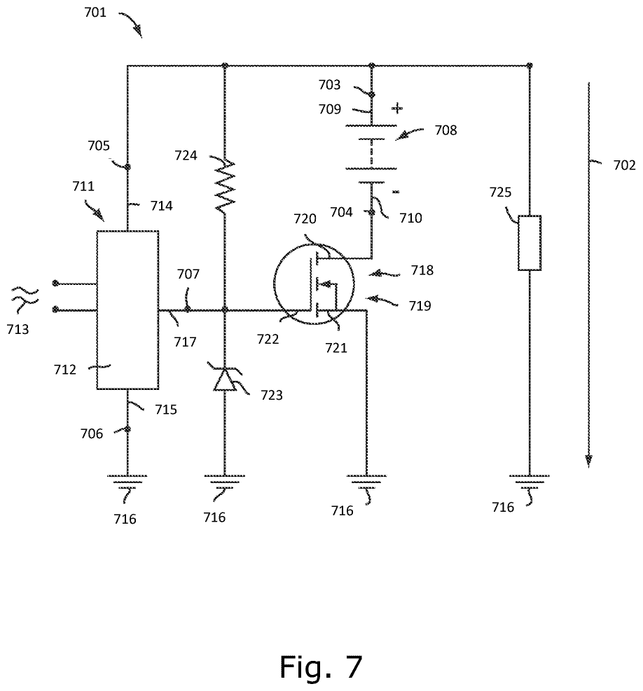

The SDD module may comprise an inverse protective element for ensuring that the polarity of the DC photovoltaic module is correct when connected to the SDD module. The SDD module may further comprise a controllable switching arrangement adapted to control an amount of power to be provided by the power unit from the photovoltaic module and/or from the AC power source. It is advantageous that at least part of the controllable switching arrangement forms part of the inverse protective element as such an arrangement will save both space and costs due to fewer components. A more detailed description is provided in relation to FIG. 7.

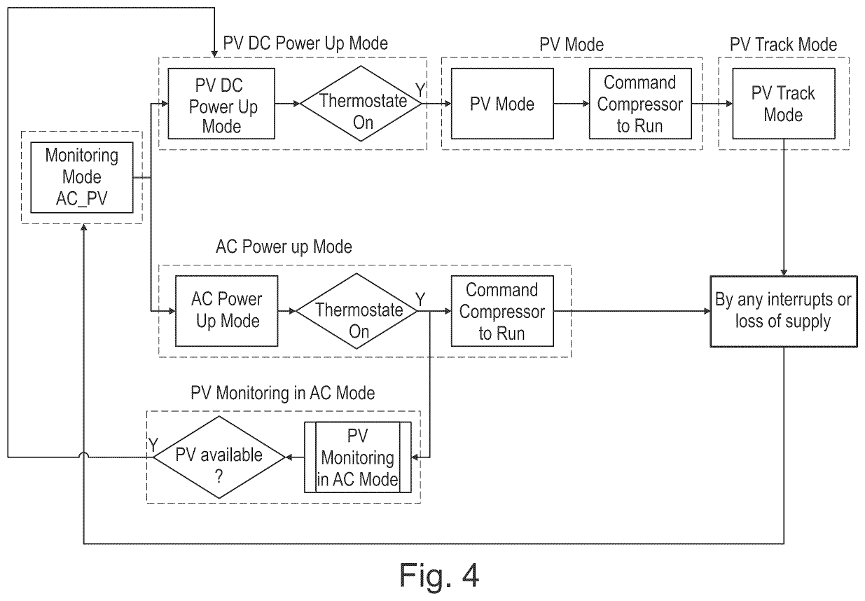

FIG. 4 shows an overall logic flow chart involving six modes of operation, namely
1) Monitoring Mode AC_PV
2) PV DC Power Up Mode
3) PV Mode
4) PV Track Mode
5) AC Power Up Mode
6) PV Monitoring in AC Mode

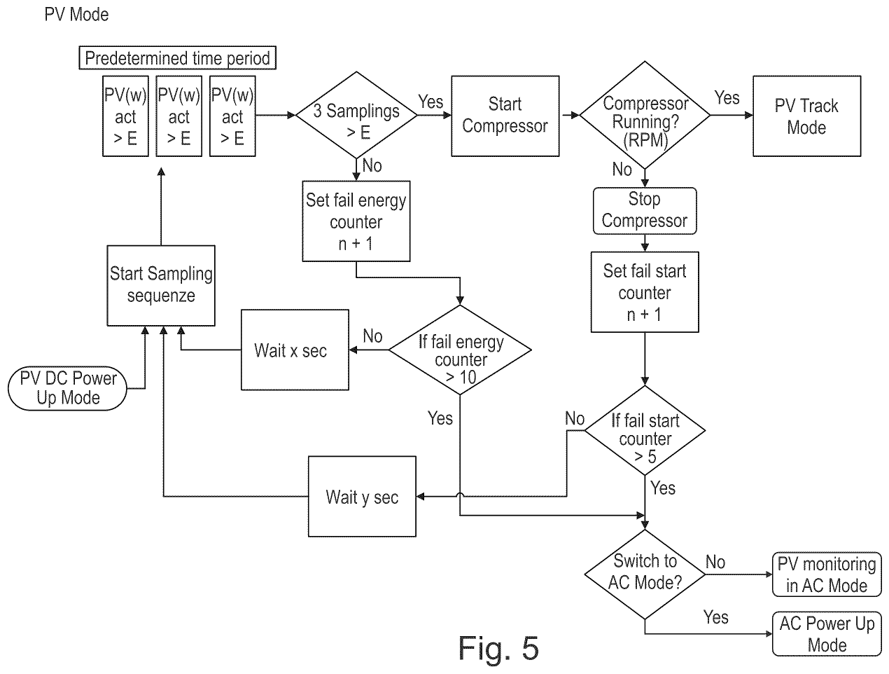

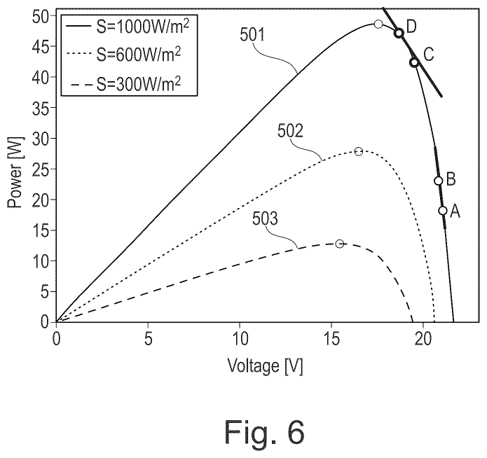

The PV Mode and the PV Track Mode will be discussed in detail in connection with FIGS. 5 and 6. In general, the Monitoring Mode AC_PV determines whether the motor, which is adapted to drive a piston compressor pump of a cooling device, should be powered 1) directly from photovoltaic panels (PV DC Power Up Mode, PV Mode and PV Track Mode), or 2) from an AC source (AC Power Up Mode). If the motor is to be powered directly from the photovoltaic panels (PV Mode) the motor is only started if the available of amount of power is equal to or exceeds a predetermined power level. The predetermined power level is determined at least twice within a time period of for example 100-300 ms. The predetermined power level for starting the motor may be at least 50 W, such as at least 60 W, such as at least 70 W, such as at least 80 W, such as at least 90 W, such as at least 100 W. When the motor and the piston compressor pump is up and running (while being directly powered by the photovoltaic panels) the PV Track Mode is entered. In short, the PV Track Mode ensures that the motor and the piston compressor pump is operated to generate maximum cooling as explained in further details in relation to FIG. 6. If the motor is to be powered from an AC power source the state of the photovoltaic panels may be monitored (PV Monitoring in AC Mode) so that the PV DC Power Up Mode may be reinstated for example when the available of amount of power from the photovoltaic module is equal to or exceeds a predetermined power level.

Turning now to FIG. 5 a logic flow chart of the PV Mode is depicted. In the following the flow chart of FIG. 5 will be explained in relation to both starting and maintaining operating of the motor. In general, and as already discussed the motor is only started if the available of amount of power from the photovoltaic module is equal to or exceeds a predetermined power level in at least two measurements (three measurements in FIG. 5). The three measurements of the available of amount of power is performed within a time period of for example 100-300 ms. As already mentioned, the predetermined power level for starting the motor may be at least 50 W, such as at least 60 W, such as at least 70 W, such as at least 80 W, such as at least 90 W, such as at least 100 W.

During operation, i.e. when power is supplied from a photovoltaic module to the SDD module, the SDD module is considered to be operated in a so-called “PV Mode”. While operating the motor and the piston compressor pump operatively connected thereto, the available amount of power, PV(w)act, from the photovoltaic module is repeatedly determining within a predetermined time period of for example 100-300 ms, cf. FIG. 5. As depicted in FIG. 5, the available amount of power, PV(w)act, is determined three times during this time period.

In the following two scenarios will be discussed
1) in the first scenario all three measurements of PV(w)act reveal that the available amount of power from the photovoltaic module is above a predetermined power value, E, whereas
2) in the second scenario at least one of the three measurements of PV(w)act reveal that the available amount of power from the photovoltaic module is below the predetermined power value, E.

The predetermined power level both for starting the motor and/or maintaining it in operation may be at least 50 W, such as at least 60 W, such as at least 70 W, such as at least 80 W, such as at least 90 W, such as at least 100 W.

Regarding the first scenario: If all three measurements of PV(w)act reveal that the available amount of power from the photovoltaic module is above a predetermined power value, E, then the motor is started although its speed of rotation may be adjusted in accordance with the determined available amount of power, i.e. the measured and thus the actual value of PV(w)act. The available amount of power from the photovoltaic module is determined from associated P-V curves of the photovoltaic module by measuring the voltage provided by the photovoltaic module using the measuring device 302, cf. FIG. 3. As it will be discussed in further details in relation to FIG. 6 P-V curves of photovoltaic modules associate a voltage provided by the photovoltaic module with an actual amount of available power. If the piston compressor pump operatively connected to the motor is also running after a certain time period (typically larger than 200 ms), the SDD module enters a so-called “PV Track Mode” of operation, cf. the discussion in relation to FIG. 6. However, if the piston compressor pump is for some reason not running properly, the piston compressor pump is stopped and the value of a “fail start counter” is increased by one. When the value of the “fail start counter” exceeds five, i.e. it has been detected more than five times that the piston compressor pump is not running properly, the intention to operate the SDD module in “PV Track Mode” is aborted, and it then has to be decided if the SDD module should switch to one of two “AC Modes”. The SDD module may be switched to the so-called “AC Power Up Mode” where the SDD module, cf. FIG. 3, receives its input power from the optional AC power source. Alternatively, the SDD module may be switched to a so-called “PV monitoring in AC Mode” where the available amount of power from the photovoltaic module, PV(w)act, is monitored with the intention to switch back in the “PV Track Mode” as soon as possible.

If the value of the “fail start counter” is below or equal to five the SDD module will wait a time period, y sec, and then perform three new measurements of PV(w)act again (Start Sampling Sequence). This time period may be up to a few minutes.

Regarding the second scenario: If at least one of the three measurements of PV(w)act reveal that the available amount of power from the photovoltaic module is below the predetermined power value, E, the operation of the motor will not be started, and the value of a so-called “fail energy counter” is increased by one. When the value of the “fail energy counter” exceeds ten, i.e. it has been detected more than ten times that the available amount of power from the photovoltaic module is below the predetermined power value, E, it has to be decided if the SDD module should switch to one of two “AC Modes”. The SDD module may be switched to the so-called “AC Power Up Mode” where the SDD module, cf. FIG. 3, receives its input power from the optional AC power source. Alternatively, the SDD module may be switched to the so-called “PV monitoring in AC Mode” where the available amount of power from the photovoltaic module, PV(w)act, is monitored with the intention to switch back in the “PV Track Mode” as soon as possible.

If the value of the “fail energy counter” is below or equal to ten the system will wait a time period, x sec, and then perform three new measurements of PV(w)act again (Start Sampling Sequence). This time period may be some tens of seconds.

In relation to the logic flow chart depicted in FIG. 5 it should be noted that the various counter values, the number of measurements of PV(w)act, predetermined power levels, predetermined time periods, delay times etc. may differ from the values listed in relation to FIG. 6.

Turning now to FIG. 6 the principle of the PV Track Mode is illustrated via the three P-V curves 501, 502, 503 of the same photovoltaic module. As indicated in FIG. 6 the P-V curves 501, 502, and 503 are associated with different incoming light intensities of 1000 W/m², 600 W/m² and 300 W/m², respectively. Each of the three P-V curves shows how the available amount of power can be determined from the terminal voltage of the photovoltaic module. The available amount of power may thus be determined from a measurement of the terminal voltage of the photovoltaic module. For example, at a terminal voltage of 15 VDC, the available amount of power will be around 46 W, 27 W and 13 W for the P-V curves 501 (1000 W/m²), 502 (600 W/m²) and 503 (300 W/m²), respectively. Thus, the available amount of power at a given terminal voltage strongly depends on the amount of incoming sun light.

The maximum available power also varies with the incoming sun light. As seen in FIG. 6 the P-V curve 501 (1000 W/m²) reveals a maximum power of around 50 W at a terminal voltage of around 17 VDC, and the P-V curve 502 (600 W/m²) reveals a maximum power of around 28 W at a terminal voltage of around 16 VDC, and the P-V curve 503 (300 W/m²) reveals a maximum power of around 13 W at a terminal voltage of around 15 VDC.

Preferably, the SDD module aims at operating the motor at a working point with maximum available power from the photovoltaic module, i.e. at or near the maximum power level of the P-V curves 501, 502, and 503, as this allows that the motor and the piston compressor pump can be operated at the highest possible rotational speed, and thus provide maximum cooling. Operating the motor and the piston compressor pump at maximum cooling is advantageous in that excess cooling may be stored in an ice bank for later cooling purposes. The duration of such later cooling purposed may be several days.

In order to operate at a working point with maximum available power (from the photovoltaic module) the value and sign of dv/dw is constantly monitored. As seen in FIG. 6 it would be advantageous to move from working point A to working point B as this increases the amount of available power. Moreover, it would be advantageous to move from working point B to working point C as this increases the amount of available power even further. An even further adjustment to working point D might also be advantageous. Thus, by constantly monitoring dv/dw it is possible to operate at or near the maximum available power of the photovoltaic module and thus, at any time, provide maximum cooling. This is advantageous in that the number of starts and stops of the motor and the piston compressor pump connected thereto can be significantly reduced, and as a consequence, the life time of the motor and the piston compressor pump is significantly increased due to less wear.

FIG. 7 shows a schematic view of a power unit 701 for the supply of a direct voltage 702, the power unit having a first connection arrangement 703, 704 and a second connection arrangement 705, 706, 707. A first direct voltage source 708, such as a photovoltaic module, is connected to the first connection arrangement 703, 704. Here, the first direct voltage source 708 comprises two units, which are connected to each other. Accessible from the outside are a positive connection 709 and a negative connection 710 of the first direct voltage source 708. The first direct voltage source 708 is electrically connected to the first connection arrangement 703, 704 in such a manner that the positive connection 709 of the first direct voltage source 708 is connected to the positive connection 703 of the connection arrangement 703, 704 and the negative connection 710 of the first direct voltage source 708 is connected to the negative pole 704 of the first connection arrangement. The first direct voltage source 708 is thus connected properly and not with reversed polarity.

A second direct voltage source 711 comprising a rectifier 712 that is supplied from an external AC power source 713, such as a power grid or a genset, is connected to the second connection arrangement 705, 706, 707. A positive connection 714 of the second direct voltage source 711 is connected to a positive connection 705 of the second connection arrangement 705, 706, 707. A negative connection 715 of the second direct voltage source 711 is connected to a negative connection 706 of the second connection arrangement 705, 706, 707. The negative connection 706 of the second connection arrangement 705, 706, 707 is at the same time connected to a reference potential 716 of the power unit 701. In the present case the second connection arrangement 705, 706, 707 has a further connection, here used as control connection 707. This control connection 707 is connected to a control outlet 717 of the second direct voltage source 711.

In the present case, the output voltage of the second direct voltage source 711 between the positive connection 705 and the negative connection 706 amounts to 27 Volt. This is also the output voltage of the rectifier 712. In the present case, the output voltage of the first direct voltage source 708 between the positive connection 709 and the negative connection 710 amounts to 12 Volt. Thus, the output voltage of the first direct voltage source 708 is smaller than the output voltage of the second direct voltage source 711. Due to the potential difference, a charge equalisation from the second direct voltage source 711 to the first direct voltage source 708 would take place, if no further measures were taken. However, this is prevented by an inverse protective element 718 in the form of a field-effect-transistor 719 comprising a drain connection 720, a source connection 721 and a gate connection 722. The field-effect-transistor 719 is, for example, of the type 2804 from International Rectifier.

The field-effect-transistor is electrically connected in series to the first direct voltage source 708. The drain connection 720 is connected to the negative connection 704 of the first connection arrangement 703, 704. The source connection 721 is connected to the reference potential 716 of the power unit 701. The gate connection of the field-effect-transistor 719 is connected to the control connection of the second connection arrangement 705, 706, 707. Between the gate connection 722 and the control connection 707 an electrical connection branches off, which comprises a diode 723, here in the form of a Zener diode and leads to the reference potential 716 of the power unit 701. The diode 723 blocks current flow from the gate connection 722 in the direction of the reference potential 716. From the gate connection 722 and from the control connection 707 a further electrical connection leads to the positive connection 703 of the first connection arrangement 703, 704 and at the same time to the positive connection 705 of the second connection arrangement 705, 706, 707. In this path an ohmic resistor 724 with a value of 330 kΩ is located in parallel to the series connection of the first direct voltage source 708 and the inverse protective element 718.

In the following, three different modes of operation of the power unit 701 will be considered. In all three modes of operation the first direct voltage source 708 is connected to the first connection arrangement. In the first mode of operation a second direct voltage source 711 is not available. Thus, no specified voltage is available at the positive connection 705, the negative connection 706 and the control connection 707 of the second connection arrangement 705, 706, 707, so that these connections 705, 706, 707 can assume arbitrary states.

A load 725 is dimensioned for a first direct voltage range between 9.6 and 17 Volts and a second direct voltage range between 21 and 31 Volt. The supply voltages of the first and the second direct voltage sources 708, 711 lie within these ranges, namely about 12 Volts and 24 Volts, respectively. The direct voltages supplied by the first and the second direct voltage sources 708, 711 could, for example, be increased to 48 Volts by a converter, to supply, for example, a compressor as the load 725. The connected load 725 is, for example, one or more direct voltage consumers.

In the first mode of operation the first direct voltage source 708 is connected properly with correct polarity, that is, not reversed polarity, to the first connection arrangement 703, 704. The second direct voltage source 711 is not available. The first direct voltage source 708 provides approximately 12 Volts as output voltage. This causes a current through the ohmic resistor 724 and the diode 723. As the diode 723 with a breakdown voltage of 15 Volts permits practically no passage of current, a voltage drop at the field-effect transistor 719 occurs between the gate connection 722 and the source connection 721. This voltage drop causes the field-effect-transistor 719 to remain in the connected state. In the connected state of the field-effect-transistor 719 a current flows in the field-effect-transistor 719 from the drain connection 720 via the source connection 721 to the reference potential 716. Thus, the first direct voltage source 708 is connected in parallel to a connected load 725, which is continuously supplied with a constant direct voltage by the first direct voltage source 708.

In the second mode of operation the first direct voltage source 708 is connected with reversed polarity to the first connection arrangement 703, 704, and the second direct voltage source 711 is not connected to the second connection arrangement 705, 706, 707. Here, the field-effect-transistor 719 prevents a current flow to the connected load 725. This occurs in that now a negative voltage is available at the field-effect-transistor 719 between the gate connection 722 and the source connection 721. This keeps the field-effect-transistor 719 in a closed state and prevents a current flow from the negative connection 710 of the first direct voltage source 708 to the reference potential 716. A direct voltage 702 is then not available at the load 725. Thus, the connected consumer(s) as the load 725 is(are) protected in the case of reversed polarity of the first direct voltage source 708.

In the third mode of operation of the power unit 701 the second direct voltage source 711 is connected with an output voltage of 27 Volts to the second connection arrangement 705, 706, 707, as shown in FIG. 7 and described above. At its control outlet 717 the second direct voltage source 711 provides a control voltage, which is in the present case zero Volts. The first direct voltage source 708 with an output voltage of 12 Volts is here connected properly with correct polarity, that is, not reversed polarity, to the first connection arrangement 703, 704. As soon as the second direct voltage source 711 is available, the potential at the control connection 707 of the second connection arrangement 705, 706, 707 is kept at zero Volts, so that also the gate connection 722 of the field-effect-transistor 719 assumes a potential of zero Volts. Between the drain connection 720 and the gate connection 722 there are then approximately 15 Volt. This keeps the field-effect-transistor 719 in its disconnected state and a current flow from the drain connection 720 to the reference potential 716 is not possible. This means that at this moment the first direct voltage source 708 is inactive. It is neither discharged, nor is it charged by the second direct voltage source 711. In this mode of operation the load 725 is supplied with a constant direct voltage 702 from the second direct voltage source 711.

All in all, the wiring of the field-effect-transistor 719 prevents a malfunction of the power unit 701 in the case of a reversed polarity of the first direct voltage source 708 and a charging and discharging of the first direct voltage source 708, when a second direct voltage source 711 is available. Thus, the field-effect-transistor 719 assumes two functions, so that the power unit 701 for supplying a direct voltage 702 is simplified without neglecting the safety aspects.

Of course, it is also possible that during the anticipated operation the described power unit 701 is operated by a first direct voltage source 708 without reversed polarity, the positive connection 709 of the first direct voltage source 708 being connected to the inverse protective element 718. Accordingly, also the connections 714, 715 of the second direct voltage source 711 are interchanged, so that the positive connection 714 is connected to the connection 706 and the negative connection 715 is connected to the connection 705 of the second connection device. Here, the reference potential 716 can be maintained, thus assuming a positive potential. It is also possible that at the negative connections 710, 715 of the first and second direct voltage sources 708, 711 the power unit 701 receives a new reference potential. With such a modified power unit 701 the blocking and passage functions of the diode 723 and the field-effect-transistor 719 or another protective element have to be adapted to the changed polarity. This can, for example, be done by interchanging the connections of these electrical components. It is also possible to use a different type of field-effect-transistor, which works as described above, however, with changed polarity.

Although the invention has been discussed in the foregoing with reference to exemplary embodiments of the invention, the invention is not restricted to these particular embodiments which can be varied in many ways without departing from the invention. The discussed exemplary embodiments shall therefore not be used to construe the appended claims strictly in accordance therewith. On the contrary, the embodiments are merely intended to explain the wording of the appended claims, without intent to limit the claims to these exemplary embodiments. The scope of protection of the invention shall therefore be construed in accordance with the appended claims only, wherein a possible ambiguity in the wording of the claims shall be resolved using these exemplary embodiments.

1.-25. (canceled)

26. A method for powering a motor directly from a photovoltaic module, wherein the motor is adapted to drive a piston compressor pump, the method comprising the steps of:
a) determining an available amount of power from the photovoltaic module, and starting the motor if the available amount of power exceeds a predetermined power level,
b) repeatedly determining, within a predetermined time period, an available amount of power from the photovoltaic module while operating the motor, and
c) adjusting the speed of rotation of the motor in accordance with the repeatedly determined available amount of power.

27. The method according to claim 26, wherein the determined available amount of power from the photovoltaic module prior to stating the motor is determined using a P-V curve of the photovoltaic module.

28. The method according to claim 26, wherein the repeatedly determined available amount of power from the photovoltaic module is determined using a P-V curve of the photovoltaic module while operating the motor.

29. The method according to claim 26, wherein the speed of rotation of the motor is essentially proportional to the repeatedly determined available amount of power from the photovoltaic module.

30. The method according to claim 26, wherein the repeatedly determined available amount of power from the photovoltaic module is determined at least twice within the predetermined time period.

31. The method according to claim 26, wherein the predetermined time period is between 100-300 ms.

32. The method according to claim 31, wherein the predetermined time period is approximately 200 ms.

33. The method according to claim 26, wherein the predetermined power level for starting the motor is at least 50 W.

34. The method according to claim 26, wherein the photovoltaic module comprises one or more photovoltaic panels.

35. A power unit for powering a motor directly from a photovoltaic module, wherein the motor is adapted to drive a piston compressor pump, the power unit comprising:
a) a first arrangement for determining an available amount of power from the photovoltaic module,
b) a converter for starting the motor if the determined available amount of power from the photovoltaic module exceeds a predetermined power level, and
c) a second arrangement for repeatedly determining, within a predetermined time period, an available amount of power from the photovoltaic module while operating the motor, and adjusting, using the converter, the speed of rotation of the motor in accordance with the repeatedly determined available amount of power.

36. The power unit according to claim 35, wherein the first arrangement is adapted to determine the available amount of power from the photovoltaic module using a P-V curve of the photovoltaic module.

37. The power unit according to claim 35, wherein the second arrangement is adapted to repeatedly determine the available amount of power from the photovoltaic module using a P-V curve of the photovoltaic module while operating the motor.

38. The power unit according to claim 35, wherein the converter is adapted to adjust the speed of rotation of the motor so that it is essentially proportional to the repeatedly determined available amount of power from the photovoltaic module.

39. The power unit according to claim 35, wherein the photovoltaic module comprises one or more photovoltaic panels.

40. The power unit according to claim 35, further being configured for powering the motor at least partly from an external AC power source.

41. The power unit according to claim 40, further being configured for powering the motor at least partly from an AC power grid and/or an AC genset.

42. A cooling device for cooling pharmaceuticals comprising a power unit according to claim 35, and an ice bank for separate cooling purposes of the cooling device.

43. A power unit for powering a motor adapted to drive a piston compressor pump, the power unit comprising
a) a DC power input port adapted to be operationally connected to a DC photovoltaic module, and an inverse protective element for ensuring that the polarity of the DC photovoltaic module at the DC power input port is correct,
b) an AC power input port adapted to be operationally connected to an external AC power source, and
c) a controllable switching arrangement adapted to control an amount of power to be provided by the power unit via the DC power input port and/or the external AC power input port, wherein at least part of the controllable switching arrangement forms part of the inverse protective element.

44. The power unit according to claim 43, wherein the power unit further comprises a power controller adapted to determine an available power from the DC photovoltaic module.

45. The power unit according to claim 44, wherein the power unit is adapted to power the motor at least partly from the external AC power source if the available power from the DC photovoltaic module is insufficient for powering the motor.

46. The power unit according to claim 43, wherein the power unit is adapted to power the motor exclusively from the DC photovoltaic module or from the external AC power source.

47. The power unit according to claim 43, wherein the DC photovoltaic module comprises one or more photovoltaic modules or panels, and
wherein the external AC power source comprises an AC power grid and/or an AC genset.

48. A cooling device for cooling pharmaceuticals comprising a power unit according to claim 43, and an ice bank for separate cooling purposes of the cooling device,
wherein the power unit powers a motor adapted to drive a piston compressor pump of the cooling device.

49. A method for powering a motor adapted to drive a piston compressor pump, the method comprising the steps of providing a power unit comprising:
a) a DC power input port adapted to be operationally connected to a DC photovoltaic module, and an inverse protective element for ensuring that the polarity of the DC photovoltaic module at the DC power input port is correct,
b) an AC power input port adapted to be operationally connected to an external AC power source, and
c) a controllable switching arrangement adapted to control an amount of power to be provided by the power unit via the DC power input port and/or the external AC power input port, wherein at least part of the controllable switching arrangement forms part of the inverse protective element
and controlling the controllable switching arrangement in accordance with a predetermined control scheme.

50. The method according to claim 49, wherein the predetermined control scheme comprises the step of determining an available power from the DC photovoltaic module.

51. The method according to claim 50, wherein the predetermined control scheme comprises the step of powering the motor at least partly from the external AC power source if the available power from the DC photovoltaic module is insufficient for powering the motor, or
wherein the predetermined control scheme comprises the step of powering the motor exclusively from the DC photovoltaic module or from the external AC power source.

52. The method according to claim 49, wherein the DC photovoltaic module comprises one or more photovoltaic modules or panels, and
wherein the external AC power source comprises an AC power grid and/or an AC genset.
